(19) United States
(12) Patent Application Publication
(10) Pub. No.: US 2016/0035043 A1
(43) Pub. Date: Feb. 4, 2016

(54) INFORMATION PROCESSING SYSTEM, ELECTRONIC APPARATUS, INFORMATION PROCESSING METHOD, AND COMPUTER-READABLE RECORDING MEDIUM

(71) Applicant: Shuichi Usui, Saitama (JP)

(72) Inventor: Shuichi Usui, Saitama (JP)

(73) Assignee: RICOH COMPANY, LTD., Tokyo (JP)

(21) Appl. No.: 14/809,452

(22) Filed: Jul. 27, 2015

(30) Foreign Application Priority Data
Aug. 1, 2014 (JP) 2014-158175

(51) Int. Cl. G06Q 40/00; H04N 1/50; H04N 1/00; G06Q 30/02

(52) U.S. Cl. CPC G06Q 40/12; G06Q 30/0283; H04N 1/50; H04N 1/00854; H04N 1/00832; H04N 2201/0094

(57) ABSTRACT

An information processing system according to the invention is an information processing system including one or more information processing devices and includes a specifying unit. The specifying unit specifies a cost price of merchandise corresponding to service identification information using first information in which each of a plurality of pieces of apparatus identification information identifying a plurality of electronic apparatuses is associated with the cost price of the merchandise for providing a service linked to the corresponding electronic apparatus, and second information in which the pieces of apparatus identification information identifying the electronic apparatuses that are available to customers are associated at least with the service identification information identifying the service.

### CROSS-REFERENCE TO RELATED APPLICATIONS

The present application claims priority to and incorporates by reference the entire contents of Japanese Patent Application No. 2014-158175 filed in Japan on Aug. 1, 2014.

### BACKGROUND OF THE INVENTION

1. Field of the Invention

The present invention relates to an information processing system, an electronic apparatus, an information processing method, and computer-readable recording medium.

2. Description of the Related Art

Conventionally, a service for guaranteeing maintenance support (for example, failure handling) of a plurality of electronic apparatuses such as image forming apparatuses and allowing a contract party to use the electronic apparatuses has been known. In this service, a unit price of the service is set in anticipation of additional service cost such as maintenance support cost, rental cost of the electronic apparatuses, and movement of the electronic apparatuses and the unit price is multiplied by usage amounts (for example, the numbers of print sheets in the case of the image forming apparatuses) of functions of the respective electronic apparatuses so as to calculate compensation for the service, in general.

For example, Japanese Patent Application Laid-open No. 2013-65205 discloses a technique of calculating cost of an apparatus at a delivery designation based on supply information including counter information such as the number of copied sheets by the apparatus.

The above-mentioned service and pieces of merchandise (maintenance support, rental of the electronic apparatuses, and the like) for providing the above-mentioned service are provided in different forms. Due to this, it has been difficult to specify cost prices of the pieces of merchandise as a raw price of the above-mentioned service.

### SUMMARY OF THE INVENTION

It is an object of the present invention to at least partially solve the problems in the conventional technology.

According to the present invention, there is provided an information processing system including one or more in processing devices, the information processing system comprising: a specifying unit configured to specify a cost price of merchandise corresponding to service identification information using: first information in which each of a plurality of pieces of apparatus identification information identifying a plurality of electronic apparatuses is associated with the cost price of the merchandise for providing a service linked to the corresponding electronic apparatus; and second information in which the pieces of apparatus identification information identifying the electronic apparatuses are associated at least with the service identification information identifying the service.

The present invention also provides an electronic apparatus that is used in the above-described information processing system.

The present invention also provides an information processing method comprising: specifying a cost price of merchandise corresponding to service identification information using: first information in which each of a plurality of pieces of apparatus identification information identifying a plurality of electronic apparatuses is associated with the cost price of the merchandise for providing a service linked to the corresponding electronic apparatus; and second information in which the pieces of apparatus identification information identifying the electronic apparatuses are at least associated with the service identification information identifying the service.

The present invention also provides a non-transitory computer-readable recording medium that contains a computer program that causes a computer to execute: specifying a cost price of merchandise corresponding to service identification information using: first information in which each of a plurality of pieces of apparatus identification information identifying a plurality of electronic apparatuses is associated with the cost price of the merchandise for providing a service linked to the corresponding electronic apparatus; and second information in which the pieces of apparatus identification information identifying the electronic apparatuses are at least associated with the service identification information identifying the service.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of the configuration of a system according to an embodiment of the present invention;

FIG. 2 is a diagram illustrating an example of the configuration of a service provision system;

FIG. 3 is a diagram illustrating an example of the hardware configuration of each of a purchase information management device, an accounting data management device, a contract information management device, and a usage amount information management device;

FIG. 4 is a table illustrating an example of purchase information;

FIG. 5 is a table illustrating an example of contract information;

FIG. 6 is a table illustrating another example of the contract information;

FIG. 7 is a table illustrating still another example of the contract information;

FIG. 8 is a table illustrating an example of accounting data;

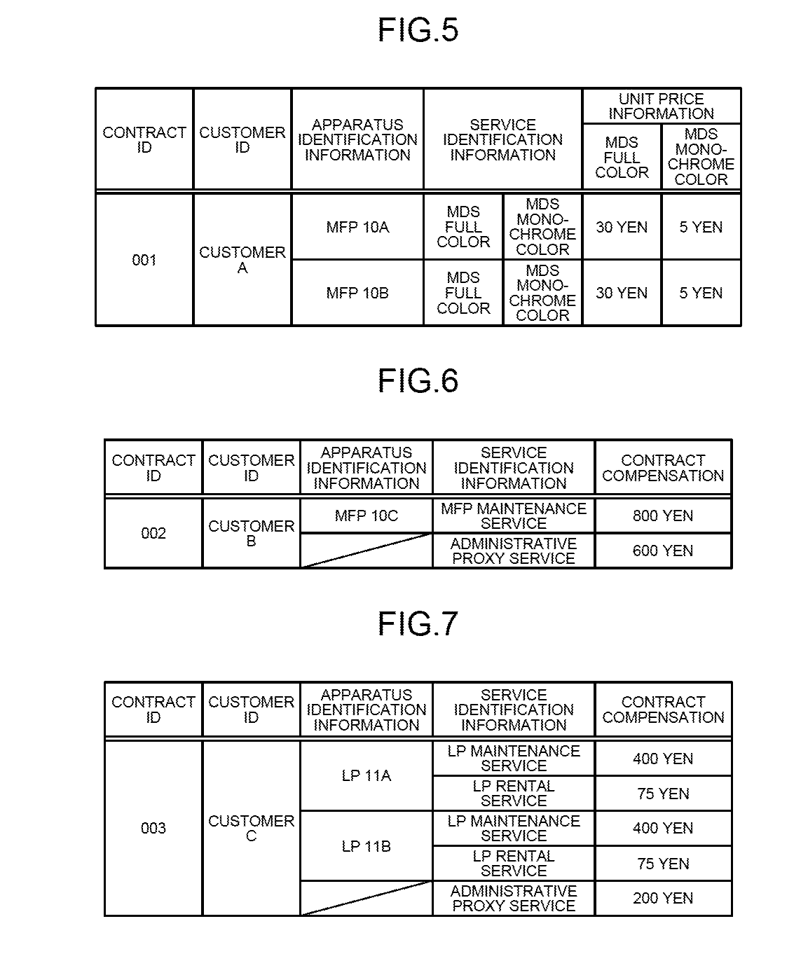

FIG. 5 is a table illustrating another example of the accounting data;

FIG. 10 is a table illustrating still another example of the accounting data;

FIG. 11 is a flowchart illustrating an operation example of the accounting data management device; and

FIG. 12 is a diagram illustrating a comparison example.

### DETAILED DESCRIPTION OF THE PREFERRED EMBODIMENTS

Hereinafter, embodiments of an information processing system, an electronic apparatus, an information processing method, and a computer-readable recording medium having a computer program according to the invention will be described in detail with reference to the accompanying drawings.

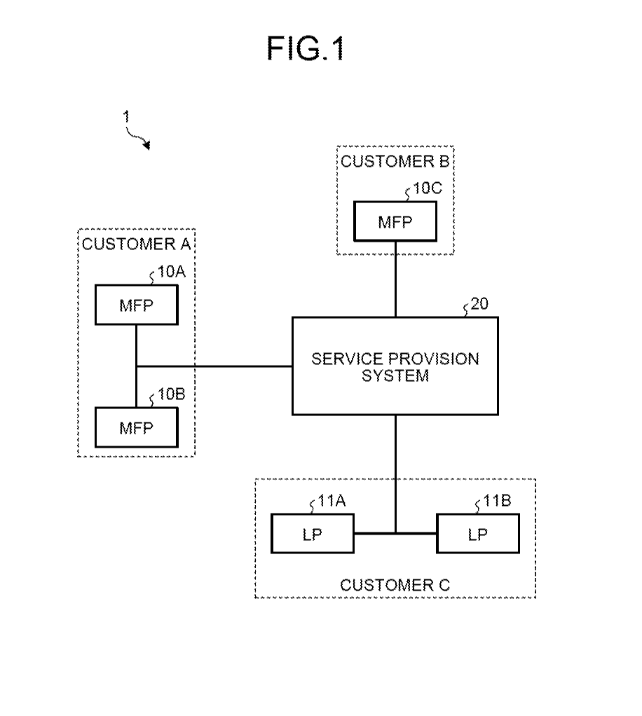

FIG. 1 is a diagram illustrating an example of the configuration of a system 1 according to the embodiment. As illustrated in FIG. 1, the system 1 includes a service provision system 20 providing services of various types using electronic apparatuses, two MFPs 10A and 10B that are available to a customer A as a target (service provision target) to which a service is provided, one MFP 10C that is available to a customer B as a service provision target, and two laser printers (LP) 11A and 11B that are available to a customer C as a service provision target. In the following description, the MFPs 10A to 10C are expressed as an “MFP 10” simply in some cases when they are not distinguished. In the same manner, the LP 11A and the LP 11B are expressed as an “LP 11” simply in some cases when they are not distinguished. Furthermore, the customers A, B, and C are expressed by a “customer” simply in some cases when they are not distinguished. Although the MFPs 10 and the LPs 11 are described as examples of the electronic apparatuses in this example, the electronic apparatuses are not limited thereto. In this example, each of the plurality of MFPs 10 and the plurality of LPs 11 can communicate with the service provision system 20 through a network such as the Internet in some cases and is independent of the network in other cases. It should be noted that the number of service provision targets and the number of electronic apparatuses that are available to the service provision targets are not limited to those in the example of FIG. 1 and can be arbitrarily changed.

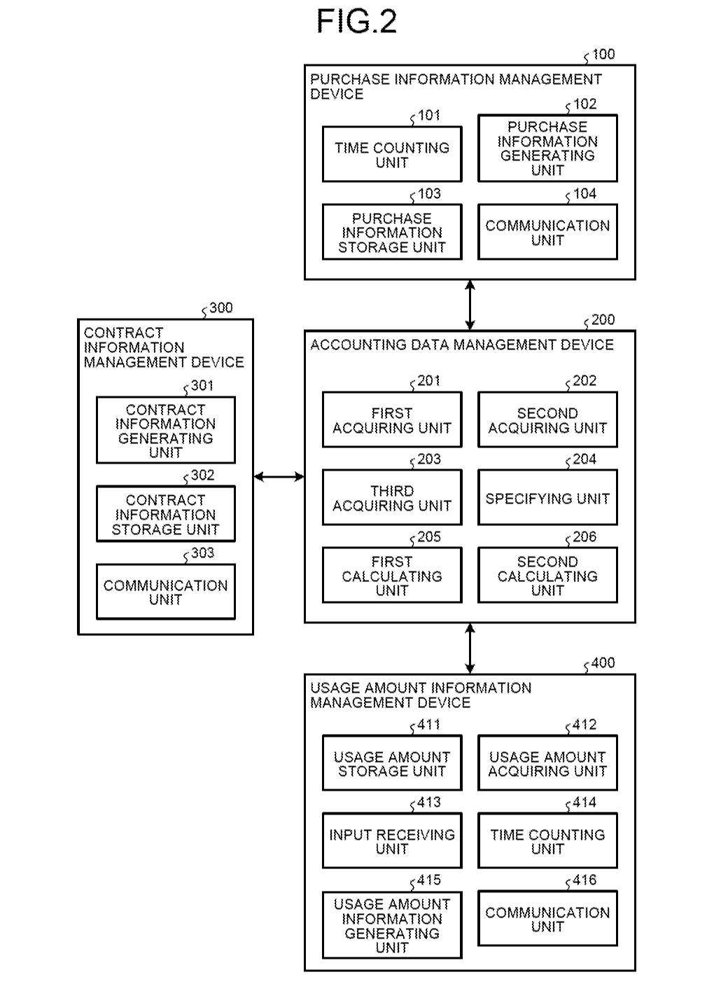

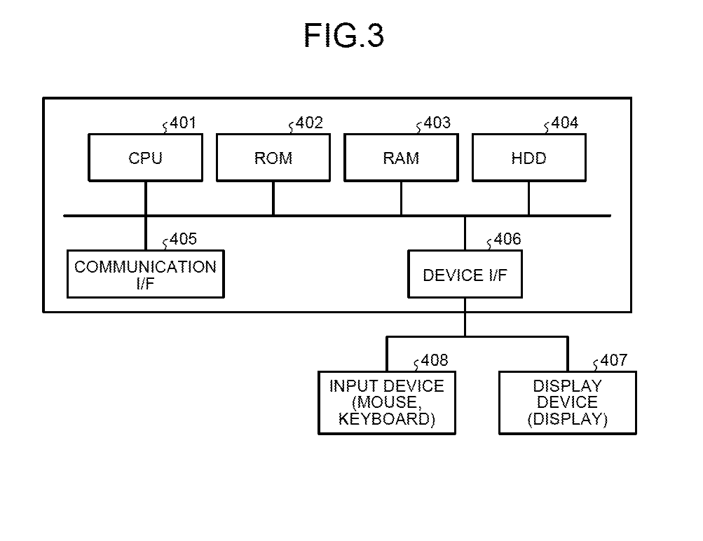

FIG. 2 is a diagram illustrating an example of the configuration of the service provision system 20. As illustrated in FIG. 2, the service provision system 20 includes a purchase information management device 100, an accounting data management device 200, a contract information management device 300, and a usage amount information management device 400. FIG. 3 is a diagram illustrating an example of the hardware configuration of each of the purchase information management device 100, the accounting data management device 200, the contract information management device 300, and the usage amount information management device 400. In this example, each of the purchase information management device 100, the accounting data management device 200, the contract information management device 300, and the usage amount information management device 400 has they hardware configuration of a common computer device including a central processing unit (CPU) 401; storage devices such as a read only memory (ROM) 402, a random access memory (RAM) 403, and a and disk drive (HDD) 404; a communication interface (I/F) 405; a device I/F 406; and a display device. (display) 407 and an input device (mouse and keyboard) 400 connected to the device I/F 406. The service provision system 20 can be made to operate by cloud services, operate through a network such as the Internet like an application service provider (ASP) (including Web services), or operate under an environment connected through a local area network (LAN) as in different organizations in the same company.

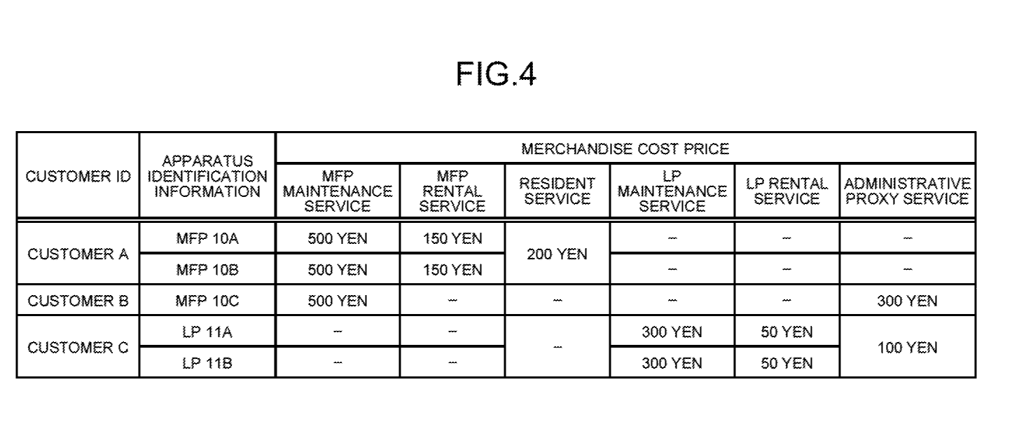

Description is continued with reference back to FIG. 2. The purchase information management device 100 includes a time counting unit 101, a purchase information generating unit 102, a purchase information storage unit 103, and a communication unit 104. In this example, the time counting unit 101 counts a unit period (for example, one month). The purchase information generating unit 102 generates purchase information indicating cost prices of pieces of merchandise that are used for providing services using the electronic apparatuses every timing at which accounting data is created in the unit period. As illustrated in FIG. 4, the purchase information is information in which pieces of apparatus identification information identifying the electronic apparatuses that are available to the customers are associated with the cost prices of the pieces of merchandise, for the respective customers. In this example, the purchase information corresponds to “first information” in the scope of the invention.

Although the services using the electronic apparatuses are provided in the embodiment, the services may not be services using the electronic apparatus as long as they are linked to the electronic apparatus. The merchandise is goods, services, or the like to be used for the services that are provided to the customer. For example, the merchandise includes services that are used for providing a service, such as apparatus rental services (lease of a commercial product), apparatus support services, and apparatus installation services for providing the service using the apparatus (the services include, one-time service as described above (for example, apparatus installation service) and a service (for example, rental service and support service) that is provided continuously or as necessary), and goods, information, and the like that are used for providing the service, such as a product, a part, a material, an assembly, a semi-product, a completed product, a content (sound, moving image, text, or the like), and information merchandise (know-how, method, case, or the like that is used for providing the service). The cost price of the merchandise indicates a value necessary for preparing the merchandise in order to use it for providing the service. For example, the cost price, includes a trading price (value) of the merchandise, a purchase price (purchase price of a product, or the like), a raw price (raw price of a material, or the like), a buying price (buying price of a part, or the like), reserve (reserve that is held for preparing the product, or the like), management cost (management cost of product stocks and the like, or the like), reward (reward to an executor of a service, or the like), and dividend. Although the cost price is expressed by an actual currency amount (in this example, a unit thereof is yen but may be dollar, for example) in the embodiment, the cost price is not limited to be expressed thereby. For example, the cost price may be expressed by an amount of electronic money (for example, Edy (registered trademark)) that makes payment using electronic data instead of the actual currency or virtual currency (for example, Bitcoin (registered trademark)) with which electronic data is manipulated as currency, or points (for example, T point (registered trademark) or Mileages (registered trademark)) that are given in accordance with purchase of products and usage of services. The same holds true for a unit price, compensation, and the like which will be described later. The above-mentioned example is merely an example and the invention can be applied to those encompassed in the above-mentioned concept or those equivalent to the above-mentioned concept.

In an example of FIG. 4, apparatus identification information identifying the “MFP 10A” and apparatus identification information identifying the “MFP 10B” are associated with a customer ID (customer information) identifying the “customer A”. An MFP maintenance service as a service that performs maintenance management of the MFP 10 and an MFP rental service as a service that lends the MFP 10 as pieces of merchandise are associated with the apparatus identification information identifying the “MFP 10A”. Furthermore, information indicating “500 yen” as a cost price of the MFP maintenance service and information indicating “150 yen” as a cost price of the MFP rental service are associated with the apparatus identification information identifying the “MFP 10A”. In the same manner, the MFP maintenance service and the MFP rental service as pieces of merchandise are associated with apparatus identification information identifying the “MFP 10B”. Furthermore, information indicating “500 yen” as a cost price of the MFP maintenance service and information indicating “150 yen” as a cost price of the MFP rental service are associated with the apparatus identification information identifying the “MFP 10B”. Moreover, information indicating “200 yen” as a cost price of a resident service as service handled by a service person who is resident is associated with the customer ID identifying the customer A. To explain differently, the resident service as the merchandise is made to commonly correspond to each of the apparatus identification information identifying the “MFP 10A” and the apparatus identification information identifying the “MFP 10B” and the information indicating “200 yen” as the cost price of the resident service is made to commonly correspond thereto.

Furthermore, in the example of FIG. 4, apparatus identification information identifying the “MFP 10C” is associated with a customer ID identifying the “customer B”. The MFP maintenance service and administrative proxy service as a service that substitutes administrative procedures as pieces of merchandise are associated with the apparatus identification information identifying the “MFP 10C”. Furthermore, information indicating “500 yen” as a cost price of the MFP maintenance service, and information indicating “300 yen” as a cost price of the administrative proxy service are associated with the apparatus identification information identifying the “MFP 10C”.

In the example of FIG. 4, apparatus identification information identifying the “LP 11A” and apparatus identification information identifying the “LP 11B” are associated with a customer ID identifying the “customer C”. An LP maintenance service as a service that performs maintenance management of the LP 11 and an LP rental service as a service that lends the LP 11 as pieces of merchandise are associated with the apparatus identification information identifying the “LP 11A”. Furthermore, information indicating “300 yen” as a cost price of the LP maintenance service and information indicating “50 yen” as a cost price of the LP rental service are associated with the apparatus identification information identifying the “LP 11A”. In the same manner, the LP maintenance service and the LP rental service as pieces of merchandise are associated with the apparatus identification information identifying the “LP 11B”. Furthermore, information indicating “300 yen” as a cost price of the LP maintenance service and information indicating “50 yen” as a cost price of the LP rental service are associated with the apparatus identification information identifying the “LP 11B”. Moreover, information indicating “100 yen” as a cost price of the administrative proxy service is associated with the customer ID identifying the “customer C”. To explain differently, the administrative proxy service as the merchandise is made to commonly correspond to each of the apparatus identification information identifying the “LP 11A” and the apparatus identification information identifying the “LP 11B”, and the information indicating “100 yen” as the cost price of the administrative proxy service, is made to commonly correspond thereto.

The purchase information generating unit 102 can generate the above-mentioned purchase information based on pieces of delivery information and the like, from delivery destinations of the pieces of merchandise, for example. The purchase information storage unit 103 stores therein the purchase information generated by the purchase information generating unit 102. The communication unit 104 is a unit that communicates with the accounting data management device 200. The communication unit 104 transmits the latest purchase information generated by the purchase, information generating unit 102 to the accounting data management device 200 every timing at which the accounting data is created in the unit period.

The accounting data management device 200 includes a first acquiring unit 201, a second acquiring unit 202, a third acquiring unit 203, a specifying unit 204, a first calculating unit 205, and a second calculating unit 206. The first acquiring unit 201 acquires the above-mentioned purchase information from the purchase information management device 100. Alternatively, the accounting data management device 200 may count the unit period and the first acquiring unit 201 may request the purchase information from the purchase information generating unit 102 every timing at which the accounting data is created in the unit period.

The second acquiring unit 202 acquires contract information, which will be described later, from the contract information management device 300. In this example, acquisition of the above-mentioned purchase information by the first acquiring unit 201 triggers the second acquiring unit 202 to request the contract information from the contract information management device 300.

The contract in management device 300 is described. The contract information management device 300 includes a contract information generating unit 301, contract information storage unit 302, and a communication unit 303. The contract information generating unit 301 generates contract information for each contract unit in accordance with input by a contract representative or the like. The contract information is information in which apparatus identification information identifying an electronic apparatus that is available to a customer is at least associated with service identification information identifying service using the electronic apparatus, and corresponds to “second information” in the scope of the invention. The contract information storage unit 302 stores therein the contract information generated by the contract information generating unit 301. The communication unit 303 is a unit that communicates with the accounting data management device 200. The communication unit 303 transmits the contract information for each contract unit that has been stored in the contract information storage unit 302 to the accounting data management device 200 in accordance with the request from the accounting data management device 200. This mode is not limiting and alternatively, the contract information management device 300 may count the unit period and the communication unit 303 may transmit the contract information for each contract unit that has been stored in the contract information storage unit 302 to the accounting data management device 200 every timing at which the accounting data is created in the unit period.

In this example, the customer A is assumed to make, with the service provision system 20, a contract for receiving provision of a service (hereinafter, referred to as “MDS full color” in some cases) that allows the customer to use a full-color copying function of the MFPs 10 and a service (hereinafter, referred to as “MDS monochrome color” in some cases) that allows the customer to use a monochrome-color copying function of the MFPs 10 while guaranteeing the maintenance support of the MFPs 10, as services using the electronic apparatuses. That is to say, the customer A is assumed to make a contract for receiving the services in a form different from the above-mentioned pieces of merchandise. The contract information in this case is information in which a contract ID identifying the contract, a customer ID identifying the customer, pieces of apparatus identification information, pieces of service identification information, and pieces of unit price information indicating predetermined unit prices of usage amounts of the functions of the electronic apparatuses are made to associated with one another. The unit prices in this case are set in anticipation of maintenance support cost and the like of the electronic apparatuses.

FIG. 5 is a table illustrating an example of the contract information corresponding to the contract with which the customer A receives provision of the MDS full color and the MDS monochrome color. As illustrated in FIG. 5, a contract ID (“001” in this example) identifying the above-mentioned contract, a customer ID identifying the customer A, pieces of apparatus identification information identifying the MFP 10A and the MFP 10B that are available to the customer A, pieces of service identification information identifying the MDS full color and the MDS monochrome color that are provided to the customer A, and pieces of unit price information indicating a predetermined unit price (“30 yen per sheet in this example) of the full-color copy per sheet and a predetermined unit price (“5 yen per sheet in this example) of the monochrome-color copy per sheet are associated with one another in the contract information. In this example, the service identification information identifying the MDS full color and the service identification information identifying the MDS monochrome color are associated with the apparatus identification information identifying the MFP 10A. The service identification information identifying the MDS full color and the service identification information identifying the MDS monochrome color are associated with the apparatus identification information identifying the MFP 10B. That is to say, in this example, it can be considered that the service identification information identifying the MDS full color corresponds to “first service identification information” in the scope of the invention and the service identification information identifying the MDS monochrome color corresponds to “second service identification information” in the scope of the invention.

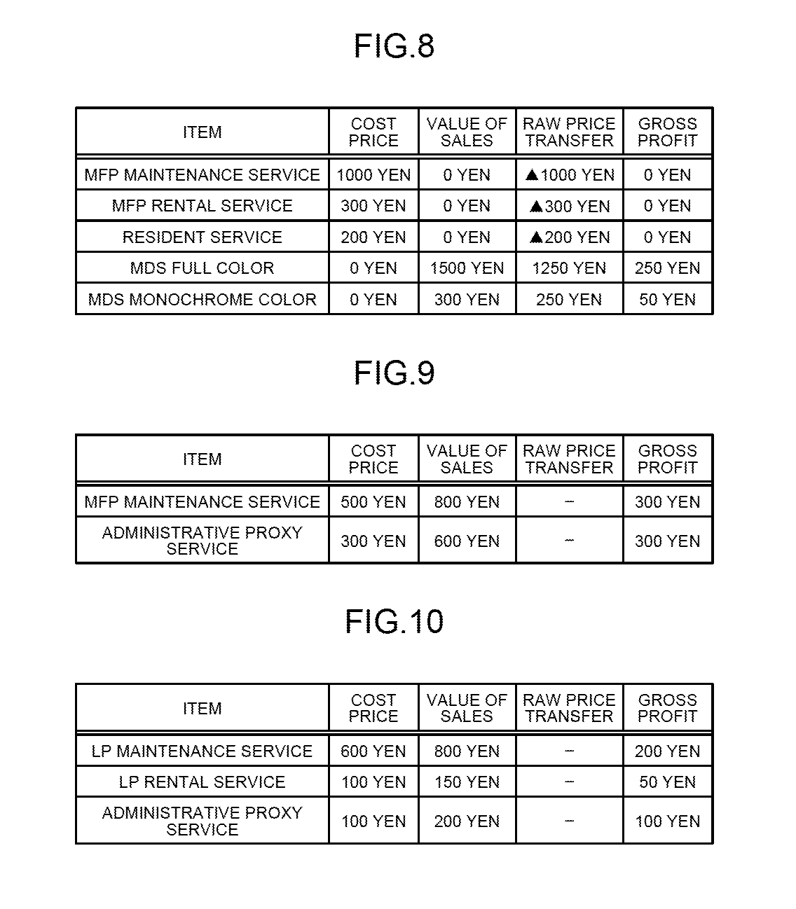

Furthermore, in this example, the customer B is assumed to make, with the service provision system 20, a contract for receiving provision of the MFP maintenance service and the administrative proxy service as services using the electronic apparatus. That is to say, the customer B is assumed to make a contract for receiving the services in the same form as the above-mentioned pieces of merchandise. The contract information in this case is information in which a contract ID, a customer ID, apparatus identification information, pieces of service identification information, and contract compensations indicating predetermined compensations (compensations of services) are associated with one another. FIG. 6 is a table illustrating an example of the contract information corresponding to the contract with which the customer B receives provision of the MFP maintenance service and the administrative proxy service. As illustrated in FIG. 6, a contract ID (“002” in this example) identifying the above-mentioned contract, a customer ID identifying the customer B, apparatus identification information identifying the MFP 10C that is available, to the customer B, pieces of service identification information identifying the MFP maintenance service and the administrative proxy service that are provided to the customer B, and contract compensation (“800 yen” in this example) of the MFP maintenance service and contract compensation (“600 yen” in this example) of the administrative proxy service are associated with one another in the contract information.

In this example, the customer C is assumed to make, with the service provision system 20, a contract for receiving provision of the LP maintenance service, the LP rental service, and the administrative proxy service as services using the electronic apparatuses. That is to say, the customer C is assumed to make a contract for receiving the services in the same form as the above-mentioned pieces of merchandise. The contract information in this case is information in which a contract ID, a customer ID, pieces of apparatus identification information, pieces of service identification information, and contract compensations are associated with one another.

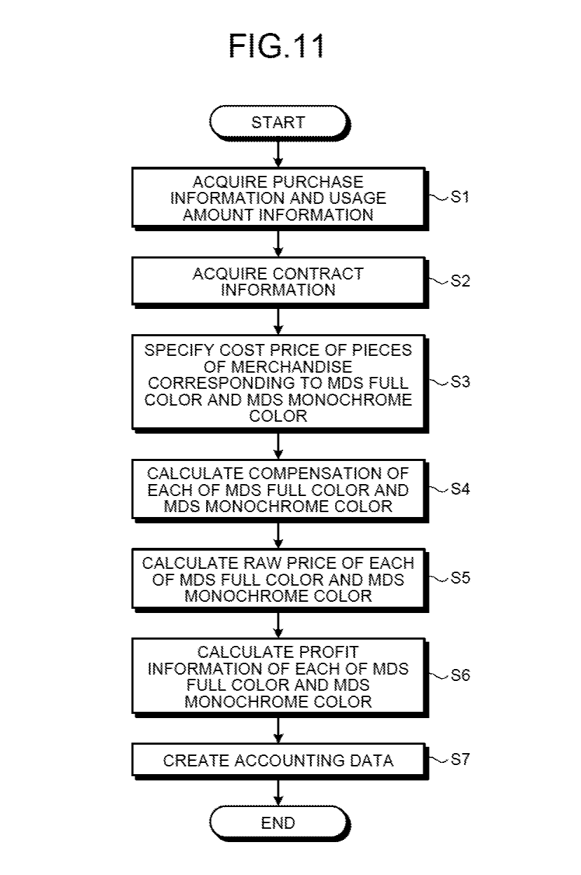

FIG. 7 is a table illustrating an example of the contract information corresponding to the contract with which the customer C receives provision of the LP maintenance service, the LP rental service, and the administrative proxy service. As illustrated in FIG. 7, a contract ID (“003” in this example) identifying the above-mentioned contract, a customer ID identifying the customer C, and pieces of apparatus identification information identifying the LP 11A and the LP 11B that are available to the customer C are associated with one another in the contract information. Service identification information identifying the LP maintenance service and service identification information identifying the LP rental service that are provided to the customer C and contract compensation (“400 yen” in this example) of the LP maintenance service and contract compensation (“75 yen” in this example) of the LP rental service are associated with the apparatus identification information identifying the LP 11A. In the same manner, the service identification information identifying the LP maintenance service and the service identification information identifying the LP rental service that are provided to the customer C and contract compensation (“400 yen” in this example) of the LP maintenance service and contract compensation (“75 yen” in this example) of the LP rental service are associated with the apparatus identification information identifying the LP 11B. Furthermore, service identification information identifying the administrative proxy service and contract compensation (“200 yen” in this example) of the administrative proxy service are associated with the customer ID identifying the customer C. To explain differently, the service identification information identifying the administrative proxy service and the contract compensation (“200 yen” in this example) of the administrative proxy service are made to commonly correspond to each of the apparatus identification information identifying the “LP 11A” and the apparatus identification information identifying the “LP 11B”.

Description of the accounting data management device 200 is continued with reference back to FIG. 2. The third acquiring unit 203 acquires usage amount information, which will be described later, from the usage amount information management device 400. In this example, the third acquiring unit 203 corresponds to an “acquiring unit” in the scope of the invention. Any one of the first acquiring unit 201, the second acquiring unit 202, and the third acquiring unit 203 may also have functions of at least one of the other two units. Then, the usage amount information management device 400 is described. The usage amount information management device 400 includes a usage amount storage unit 411, a usage amount acquiring unit 412, an input receiving unit 413, a time counting unit 414, a usage amount information generating unit 415, and a communication unit 416.

The usage amount storage unit 411 manages (stores) therein the usage amount information indicating usage amounts of the functions of the electronic apparatuses (in this example, MFPs 10 and LPs 11) that are available to the customers. For example, the usage amounts of the functions of the MFPs 10 include the number of sheets of the full-color copy and the number of sheets of the monochrome-color copy. For example, the usage amount acquiring unit 412 can access the MFPs 10 and the LPs 11 through a network so as to acquire the usage amounts of the functions of the MFPs 10 and the LPs 11. For example, when the MFPs 10 and the LPs 11 are not connected to the network, a service person (salesperson) may directly check the usage amounts of the functions of the MFPs 10 and the LPs 11 and input check results to the usage amount information management device 400. The input receiving unit 413 receives input from the service person. The usage amount storage unit 411 manages the usage amounts for the respective electronic apparatuses that are available to the service provision targets. For example, the usage amount storage unit 411 manages usage amounts for the electronic apparatuses (in this example, MFPs 10A and 10B) that are available to the customer A, a usage amount for the electronic apparatus (in this example, MFP 10C) that is available to the customer B, and usage amounts for the electronic apparatuses (in this example, LPs 11A and 11B) that are available to the customer C. The usage amount of the electronic apparatus is in accordance with a type of the electronic apparatus and the service that is provided. For example, the usage amount of the electronic apparatus may be a communication amount of data, usage time (for example, talk time of a television conference system, display time of a projector, and activation time of an electronic blackboard), the number of times (the number of display times of the projector, the number of usage times of support, the number of shooting times with a digital camera, or the like), the number of users (the number of users of a cellular phone, a mobile terminal, or the like), or the like. Thus, it is sufficient that the usage amount enables a usage state of the service using the electronic apparatus to be grasped quantitatively.

In this example, the time counting unit 414 counts the above-mentioned unit period, and the usage amount information generating unit 415 causes the usage amount acquiring unit 412 to access the respective, electronic apparatuses and acquire the usage amounts in the unit period so as to generate usage amount information every timing at which the accounting data is created in the unit period. In this example, the usage amount information is information indicating the usage amounts of the respective electronic apparatuses in the unit period. The communication unit 416 transmits the usage amount information generated by the usage amount information generating unit 415 to the accounting data management device 200.

Although the usage amount information management device 400 counts the unit period and transmits the usage amount information to the accounting data management device 200 every timing at which the accounting data is created in the unit period in this example, the mode is not limiting. Alternatively, the accounting data management device 200 may count the unit period and request the usage amount information from the usage amount information management device 400 every timing at which the accounting data is created in the unit period, for example.

Description of the accounting data management device 200 is continued again. The specifying unit 204 specifies cost prices of the pieces of merchandise corresponding to the pieces of service identification information contained in the contract information using the purchase information acquired by the first acquiring unit 201 and the contract information acquired by the second acquiring unit 202. Hereinafter, specific contents thereof are described.

First, a method of specifying the cost price of the pieces of merchandise corresponding to the pieces of service identification information contained in the contract information (contract information corresponding to the contract with which the customer A receives provision of the MDS full color and the MDS monochrome color) of the customer A will be described. As illustrated in FIG. 5, in the contract information of the customer A, each of the apparatus identification information identifying the MFP 10A and the apparatus identification information identifying the MFP 10B are associated with the service identification information identifying the MDS full color and the service identification information identifying the MDS monochrome color.

As illustrated in FIG. 4, in the purchase information, the cost price (“500 yen” in this example) of the MFP maintenance service and the cost price (“150 yen” in this example) of the MFP rental service are associated with the apparatus identification information identifying the MFP 10A. Furthermore, the cost price (“500 yen” in this example) of the MFP maintenance service and the cost price (“150 yen” in this example) of the MFP rental service are associated with the apparatus identification information identifying the MFP 10B. In addition, the cost price (“200 yen” in this example) of the resident service is made to commonly correspond to the apparatus identification information identifying the MFP 10A and the apparatus identification information identifying the MFP 10B. That is to say, the cost price (total price) of the pieces of merchandise corresponding to the apparatus identification information identifying the MFP 10A and the apparatus identification information identifying the MFP 10B is 500 yen+500 yen+150 yen+150 yen+200 yen=1500 yen. That is, in the above-mentioned contract information, the cost price of the pieces of merchandise corresponding to the service identification information identifying the MDS full color and the service identification information identifying the MDS monochrome color linked to the apparatus identification information identifying the MFP 10A and the apparatus identification information identifying the MFP 10B can be specified to be 1500 yen. Thus, even when the form of the services (MDS full color and MDS monochrome color) that are provided to the customer A and the form of the pieces of merchandise (MFP maintenance service, MFP rental service, resident service) that are used for providing the services are different, the cost price of the pieces of merchandise corresponding to the services that are provided to the customer A can be specified by using the above-mentioned purchase information and contract information. In the embodiment, the cost price of the pieces of merchandise corresponding to the service identification information identifying the MDS full color and the cost price of the pieces of merchandise corresponding to the service identification information identifying the MDS monochrome color are calculated separately. Specific contents thereof will be described later. In addition, a method of calculating compensation for each of the MDS full color and the MDS monochrome color will be also described later.

Then, a method of specifying the cost price of the pieces of merchandise corresponding to the pieces of service identification information contained in the contract information (contract information corresponding to the contract with which the customer B receives provision of the MFP maintenance service and the administrative proxy service) of the customer B will be described. As illustrated in FIG. 6, in the contract information of the customer B, the apparatus identification information identifying the MFP 10C is associated with the service identification information identifying the MFP maintenance service and the service identification information identifying the administrative proxy service.

As illustrated in FIG. 4, in the purchase information, the cost price “500 yen” in this example) of the MFP maintenance service and the cost price (“300 yen” in this example) of the administrative proxy service are associated with the apparatus identification information identifying the MFP 10C. In this example, the form of the services (MFP maintenance service and administrative proxy service) that are provided to the customer B and the form of the nieces of merchandise (MFP maintenance service and administrative proxy service) that are used for providing the services are the same. Based on this, the cost price of the merchandise corresponding to the MFP maintenance service linked to the apparatus identification information identifying the MFP 10C in the above-mentioned contract information can be specified to be the cost price (“500 yen” in this example) of the MFP maintenance service linked to the apparatus identification information identifying the MFP 10C in the purchase information. In the same manner, the cost price of the merchandise corresponding to the administrative proxy service linked to the apparatus identification information identifying the MFP 10C in the above-mentioned contract information can be specified to be the cost price (“300 yen” in this example) of the administrative proxy service linked to the apparatus identification information identifying the MFP 10C in the purchase information.

Thereafter, a method of specifying the cost price of the pieces of merchandise corresponding to the pieces of service identification information contained in the contract information (contract information corresponding to the contract with which the customer C receives provision of the LP maintenance, service, the LP rental service, and the administrative proxy service) of the customer C will be described. As illustrated in FIG. 7, in the contract information corresponding to the contract with which the customer C receives provision of the LP maintenance service, the LP rental service, and the administrative proxy service, the apparatus identification information identifying the LP 11A and the apparatus identification information identifying the LP 11B are associated with the service identification information identifying the LP maintenance service. The apparatus identification information identifying the LP 11A and the apparatus identification information identifying the LP 11B are associated with the service identification information identifying the LP rental service. Furthermore, it can be considered that the apparatus identification information identifying the LP 11A and the apparatus identification information identifying the LP 11B are associated with the service identification information identifying the administrative proxy service.

As illustrated in FIG. 4, in the purchase information, the cost price “300 yen” in this example) of the LP maintenance service and the cost price (“50 yen” in this example) of the LP rental service are associated with the apparatus identification information identifying the LP 11A. The cost price (“300 yen” in this example) of the LP maintenance service and the cost price (“50 yen” in this example) of the LP rental service are associated with the apparatus identification information identifying the LP 11B. Furthermore, the cost price (“100 yen” in this example) of the administrative proxy service is made to commonly correspond to the apparatus identification information identifying the LP 11A and the apparatus identification information identifying the LP 11B. In this example, the form of the services (LP maintenance service, LP rental service, administrative proxy service) that are provided to the customer C and the form of the pieces of merchandise (LP maintenance service, LP rental service, administrative proxy service) that are used for providing the services are the same. Based on this, the cost price, of the merchandise corresponding to the LP maintenance service linked to the apparatus identification information identifying the LP 11A and the apparatus identification information identifying the LP 11B in the above-mentioned contract information can he specified to be the total value “500 yen” in this example) of the cost price (“300 yen” in this example) of the LP maintenance service linked to the apparatus identification information identifying the LP 11A and the cost price (“300 yen” in this example) of the LP maintenance service linked to the apparatus identification information identifying the LP 11B in the purchase information.

In the same manner, the cost price of the merchandise corresponding to the LP rental service linked to the apparatus identification information identifying the LP 11A and the apparatus identification information identifying the LP 11B in the above-mentioned contract information can he specified to be the total value (“100 yen” in this example) of the cost price (“50 yen” in this example) of the LP rental service linked to the apparatus identification information identifying the LP 11A and the cost price (“50 yen” in this example) of the LP rental service linked to the apparatus identification information identifying the LP 11B in the purchase information.

Furthermore, the cost price of the merchandise corresponding to the administrative proxy service commonly linked to the apparatus identification information identifying the LP 11A and the apparatus identification information identifying the LP 11B in the above-mentioned contract information can be specified to be the cost price (“100 yen” in this example) of the administrative proxy service commonly linked to the apparatus identification information identifying the LP 11A and the apparatus identification information identifying the LP 11B in the purchase information.

Description of the accounting data management device 200 is continued with reference back to FIG. 2. As described above, the contract information when the contract for receiving the services (MDS full color and MDS monochrome color in this example) in the form different from the above-mentioned merchandise is made is information in which the contract ID identifying the contract, the customer ID identifying the customer, the apparatus identification information, the service identification information, and the unit price information indicating a predetermined unit price of a usage amount of the function of the electronic apparatus. In this case, compensation for the service that is identified by the service identification information is required to be calculated. The first calculating unit 205 calculates the compensation for the service that is identified by the service identification information contained in the above-mentioned contract information using the usage amount information acquired by the third acquiring unit 203 and the above-mentioned contract information. When a plurality of types of the service identification information are associated with the apparatus identification information contained in the contract information and the unit price information is associated with each type of the service identification information like the above-mentioned contract information of the customer A, the first calculating unit 205 calculates compensation for the service identified by the service identification information for each piece of the service identification information contained in the contract information using the usage amount information acquired by the third acquiring unit 203 and the contract information.

The case where the compensation for each of the MDS full color and the MDS monochrome color that are provided to the above-mentioned customer A is calculated is described as an example. It is supposed that in the usage amount information acquired by the third acquiring unit 203, the number of sheets of the full-color copy using the MFP 10A and the MFP 10B is “50” and the number of sheets of the monochrome-color copy is “60”. In the contract information as illustrated in FIG. 5, the unit price information (unit price per full-color copy) of the MDS full color indicates “30 yen” and the unit price information (unit price per monochrome-color copy) of the MDS monochrome color indicates “5 yen”. Based on them, the first calculating unit 205 calculates 30 yen×50 sheets=1500 yen as the compensation for the MDS full color that is provided to the customer A and the first calculating unit 205 calculates 5 yen×60 sheets=300 yen as the compensation for the MDS monochrome color that is provided to the customer A.

Then, the second calculating unit 206 is described. The second calculating unit 206 calculates, as profit information indicating profit of service that is identified by the service identification information, a value obtained by subtracting the cost price of the merchandise corresponding to the service identification information from the compensation for the service that is identified by the service identification information contained in the contract information when the contract for receiving the service, (in this example, MDS full color and MDS monochrome color) in the form different from the above-mentioned merchandise is made. For example, it is supposed that a plurality of types of the service identification information are associated with the apparatus identification information contained in the contract information and the unit price information is associated with each type of the service identification information like the above-mentioned contract information of the customer A. In this case, the second calculating unit 206 calculates, as a raw price of the service that is identified by the service, identification information, a value, obtained by distributing the cost price of the pieces of merchandise corresponding to the apparatus identification information to which the service identification information is linked in accordance with the compensation for the service that is identified by the service identification information for each service identification information. Furthermore, the second calculating unit 206 calculates, as profit information of the service that is identified by the service identification information, a value obtained by subtracting the raw price of the service that is identified by the service identification information from the compensation for the service that is identified by the service identification information. The second calculating unit performs processing of transferring the cost price of the merchandise corresponding to the service identification information contained in the contract information when the contract for receiving the service (in this example, MDS full color and MDS monochrome color) in the form different from the above-mentioned merchandise is made as the raw price of the service that is identified by the service identification information so as to generate accounting data indicating the profit information for each service and each piece of merchandise.

The case where the profit information of each of the MDS full color and the MDS monochrome color that are provided to the above-mentioned customer A is calculated is described as an example. As described above, the cost price (total value) of the pieces of merchandise corresponding to the pieces of apparatus identification information (apparatus identification information identifying the MFP 10A and apparatus identification information identifying the MFP 10B) to which the service identification information identifying the MDS full color and the service identification information identifying the MDS monochrome color contained in the contract information of the customer A are linked is specified to be 1500 yen. As described above, the compensation for the MDS full color that is identified by the service identification information contained in the contract information of the customer A is calculated to be 1500 yen and the compensation for the MDS monochrome color is calculated to be 300 yen. The second calculating unit 206 calculates, as a raw price of each of the MDS full color and the MDS monochrome color, a value obtained by distributing (dividing) 1500 yen as the cost price of the pieces of merchandise corresponding to the MDS full color and the MDS monochrome color in accordance with the compensation for each of the MDS full color and the MDS monochrome color for each of them. In this example, the second calculating unit 206 calculates 1500 yen×(1500 yen/1800 yen)=1250 yen as the raw price of the MDS full color and calculates 1500 yen×(300 yen/1800 yen)=250 yen as the raw price of the MDS monochrome color. Furthermore, the second calculating unit 206 calculates, as the profit information of the MDS full color, a value (+250 yen) provided by subtracting the raw price (1250 yen) of the MDS full color calculated as described above from the compensation (1500 yen) of the MDS full color. The second calculating unit 206 calculates, as the profit information of the MDS monochrome color, a value (+50 yen) provided by subtracting the raw price (250 yen) of the MDS monochrome color calculated as described above from the compensation. (300 yen) of the MDS monochrome color.

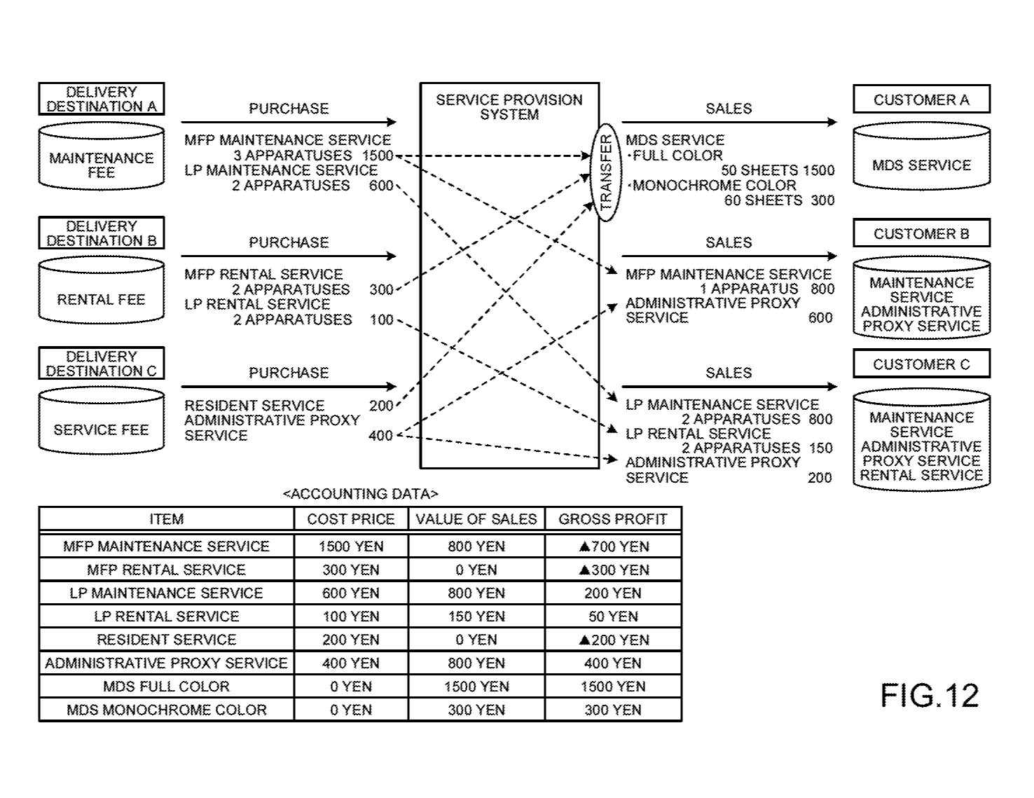

Furthermore, the second calculating unit 206 generates, as accounting data corresponding to the contract information of the customer A, accounting data indicating pieces of profit information for the MDS full color and the. MDS monochrome color, and the MFP maintenance service, the. MFP rental service, and the resident service as the pieces of merchandise that are used for providing the MDS full color and the MDS monochrome color, as illustrated in FIG. 8. In an example of FIG. 8, the cost price of the MFP maintenance service indicates the total value (“1000 yen” in this example) of the cost price (“500 yen” in this example) of the MFP maintenance service corresponding to the apparatus identification information identifying the MFP 10A linked to the MDS full color and the MDS monochrome color and the cost price (“500 yen” in this example) of the MFP maintenance service, corresponding to the apparatus identification information identifying the MFP 10B linked to the MDS full color and the MDS monochrome color. In this example, the form of the services (MDS full color and MDS monochrome color) that are provided to the customer A and the form of the MFP maintenance service as the merchandise for providing the service are different and no sales of the MFP maintenance service is generated and the value of sales of the MFP maintenance service is therefore 0 yen. The cost price of the MFP maintenance service is transferred as the raw price of the MDS full color and the MDS monochrome color, and the same value as the cost price of the MFP maintenance service is posted as a raw price transfer value. As a result, gross profit (profit information) of the MFP maintenance service is posted to be 0 yen.

In the example of FIG. 3, the cost price of the MFP rental service indicates the total value (“300 yen” in this example) of the cost price (“150 yen” in this example) of the MFP rental service corresponding to the apparatus identification information identifying the MFP 10A and the cost price (“150 yen” in this example) of the MFP rental service corresponding to the MFP 10B. Furthermore, in the same manner as the case of the MFP maintenance service, no sales of the MFP rental service is generated and the value of sales of the MFP rental service is therefore 0 yen. The cost price of the MFP rental service is transferred as the raw price of the MDS full color and the MDS monochrome color, and the same value as the cost price of the MFP rental service is posted as a raw price transfer value. As a result, a gross profit of the MFP rental service is posted to be 0 yen.

In the example of FIG. 3, the cost price of the resident service indicates the cost price (“200 yen” in this example) of the resident service corresponding to the apparatus identification information identifying the MFP 10A and the apparatus identification information identifying the MFP 10B in the purchase information of FIG. 4. In the same manner as the case of the MFP maintenance service and the MFP rental service, no sales of the resident service is generated and the value of sales of the resident service is therefore 0 yen. The value of sales of the resident service is transferred as the raw price of the MDS full color and the MDS monochrome color, and the same value as the cost price of the resident service is posted as a raw price transfer value. As a result, a gross profit of the resident service is posted to be 0 yen.

In the example of FIG. 3, compensation (1500 yen in this example) of the MDS full color calculated as described above is posted as the value of sales of the MDS full color. In this example, the form of the services (MDS full color and MDS monochrome color) that are provided to the customer A and the form of the pieces of merchandise for providing the services are different. There is no cost price of the MDS full color (the MDS full color is not contained in the purchase information of FIG. 4) and the cost price of the MDS full color is therefore 0 yen. A value (1250 yen in this example) calculated as the raw price of the MDS full color as described above is posted as the raw price transfer value. As a result, a value (250 yen in this example) provided by subtracting the raw price transfer value from the value of sales is posted as a gross profit of the MDS full color.

In the same manner, the compensation (“300 yen” in this example) of the MDS monochrome color calculated as described above is posted as the value of sales of the MDS monochrome color. Furthermore, in this example, the form of the services (MDS full color and MDS monochrome color) that are provided to the customer A and the form of the pieces of merchandise for providing the services are different. There is no cost price of the MDS monochrome color MDS monochrome color is not contained in the purchase information of FIG. 4) and the cost price of the MDS monochrome color is 0 yen. A value (250 yen in this example) calculated as the raw price of the MDS monochrome color as described above is posted as the raw price transfer value. As a result, a value (50 yen in this example) provided by subtracting the raw price transfer value from the value of sales is posted as a gross profit of the MDS monochrome color.

Furthermore, the second calculating unit 206 generates, as accounting data corresponding to the contract information of the customer B, accounting data indicating profit information for each of the MFP maintenance service and the administrative proxy service as illustrated in FIG. 9. In this example, as described above, the form of the services that are provided to the customer B and the form of the pieces of merchandise for providing the services are the same, and the pieces of merchandise and the services therefore belong to the same items. In the example of FIG. 9, the cost price of the MFP maintenance service indicates the cost price (500 yen in this example) of the MFP maintenance service corresponding to the apparatus identification information identifying the MFP 10C that is available to the customer B in the purchase information of FIG. 4. The value of sales of the MFP maintenance service indicates the contract compensation (800 yen in this example) corresponding to the MFP maintenance service in the contract information of the customer B in FIG. 6. In this case, the raw price transfer is unnecessary and a value (300 yen in this example) provided by subtracting she cost price from the value of sales is posted as a gloss profit of the MFP maintenance service.

In the example of FIG. 9, the cost price of the administrative proxy service indicates the cost price (300 yen in this example) of the administrative proxy service corresponding to the apparatus identification information identifying the MFP 10C in the purchase information of FIG. 4. The value of sales of the administrative proxy service indicates the contract compensation (600 yen in this example) corresponding to the administrative proxy service in the contract information of the customer B in FIG. 6. In this case, the raw price transfer is unnecessary and a value (300 yen in this example) provided by subtracting she cost price from the value of sales is posted as a gross profit of the administrative proxy service.

Furthermore, the second calculating unit 206 generates, as accounting data corresponding to the contract information of the customer C, accounting data indicating profit information for each of the LP maintenance service, the LP rental service, and the administrative proxy service as illustrated in FIG. 10. In this example, as described above, the form of the services that are provided to the customer C and the form of the pieces of merchandise for providing the services are the same and the pieces of merchandise and the services belong to the same items. In the example of FIG. 10, the cost price of the LP maintenance service indicates the total value (600 yen in this example) of the cost price (300 yen in this example) of the LP maintenance service corresponding to the apparatus identification information identifying the LP 11A that is available to the customer C and the cost price (300 yen in this example) of the LP maintenance service corresponding to the apparatus identification information identifying the LP 11B that is available to the customer C in the purchase information of FIG. 4. The value of sales of the LP maintenance service indicates the total value (800 yen in this example) of the contract unit price (400 yen in this example) of the LP maintenance service corresponding to the apparatus identification information identifying the LP 11A and the contract unit price (400 yen in this example) of the LP maintenance service corresponding to the apparatus identification information identifying the LP 11B in the contract information of the customer C in FIG. 7. In this case, the raw price transfer is unnecessary and a value (200 yen in this example) provided by subtracting the cost price from the value of sales is posted as a gross profit of the LP maintenance service.

In the example of FIG. 10, the cost price of the LP rental service indicates the total value (100 yen in this example) of the cost price (50 yen in this example) of the LP rental service corresponding to the apparatus identification information identifying the LP 11A and (50 yen in this example) of the LP rental service corresponding to the apparatus identification information identifying the LP 11B in the purchase information of FIG. 4. The value of sales of the LP rental service indicates the total value (150 yen in this example) of the contract unit price. (75 yen in this example) of the LP rental service corresponding to the apparatus identification information identifying the LP 11A and the contract unit price (75 yen in this example) of the LP rental service corresponding to the apparatus identification information identifying the LP 11B in the contract information of the customer C in FIG. 7 In this case, the raw price transfer is unnecessary and a value (50 yen in this example) provided by subtracting the cost price from the value of sales is posted as a gross profit of the LP rental service.

In the example of FIG. 10, the cost price of the administrative proxy service indicates the cost price (100 yen in this case) of the administrative proxy service corresponding to the apparatus identification information identifying the LP 11A and the apparatus identification information identifying the LP 11B in the purchase information of FIG. 4. The value of sales of the administrative proxy service indicates the contract unit price (200 yen in this example) of the administrative proxy service corresponding to the apparatus identification information identifying the LP 11A and the apparatus identification information identifying the LP 11B in the contract information of the customer C in FIG. 7. In this case, the raw price transfer is unnecessary and a value (100 yen in this example) provided by subtracting the cost price from the value of sales is posted as a gross profit of the administrative proxy service.

Although the second calculating unit 206 generates the accounting data for each contract information herein, it can integrate the pieces of data so as to generate accounting data indicating profit information for each item corresponding to the merchandise or the service.

FIG. 11 is a flowchart illustrating an operation example of the accounting data management device 200 when the accounting data corresponding to the contract information of the customer A is created. As described above, in the embodiment, the purchase information management device 100 transmits the purchase information to the accounting data management device 200 and the usage amount information management device 400 transmits the usage amount information to the accounting data management device 200 every timing at which the accounting data is created in the unit period. First, the first acquiring unit 201 acquires the purchase information from the purchase information management device 100 and the third acquiring unit 203 acquires the usage amount information from the usage amount information management device 400 (step S1).

Then, the second acquiring unit 202 acquires the contract information from the contract information management device 300 (step S2). As described above, in the embodiment, the acquisition of the purchase information by the first acquiring unit 201 triggers the second acquiring unit 202 to request the contract information from the contract information management device 300.

Subsequently, the specifying unit 204 specifies the cost price of the pieces of merchandise corresponding to the service identification information identifying the MDS full color and the service identification information identifying the MDS monochrome color that are contained in the contract information of the customer A using the purchase information acquired at step S1 and the contract information acquired at step S2 (step S3). The specific contents thereof are as described above. Then, the first calculating unit 205 calculates the compensation for each of the MDS full color and the MDS monochrome color that are identified by the pieces of service identification information contained in the contract information of the customer A using the usage amount information acquired at step S1 and the contract information acquired at step S2 (step S4). The specific contents thereof are as described above. Thereafter, the second calculating unit 206 calculates, as the raw price of each of the MDS full color and the MDS monochrome color, a value obtained by distributing (dividing) the cost price of the pieces of merchandise corresponding to the MDS full color and the MDS monochrome color in accordance with the compensation for each of the MDS full color and the MDS monochrome color for each of them (step S5). The specific contents thereof are as described above. Then, the second calculating unit 206 calculates the profit information of each of the MDS full color and the MDS monochrome color (step S6). The specific contents thereof are as described above. The second calculating unit 206 performs the processing of transferring the cost prices of the pieces of merchandise corresponding to the MDS full color and the MDS monochrome color as the raw prices of the MDS full color and the MDS monochrome color, respectively, so as to generate the accounting data indicating the profit information for each of the MDS full color, the MDS monochrome color, and the pieces of merchandise (as described above, MFP maintenance service, MFP rental service, resident service in this case) that are used for providing the MDS full color and the MDS monochrome color (step S7). The specific contents thereof are as described above.

As a comparison example of the embodiment, the configuration (FIG. 12) in which the cost prices of the pieces of merchandise corresponding to the MDS full color and the MDS monochrome color are not specified and the processing of transferring the cost prices of the pieces of merchandise corresponding to the MDS full color and the MDS monochrome color as the raw prices of the MDS full color and MDS monochrome color is not performed is supposed. In accounting data as illustrated in FIG. 12, no sales of the MFP maintenance service, the MFP rental service, and the resident service that are used for providing the MDS full color and the MDS monochrome color is generated, so that values of posted gloss profits thereof become small unreasonably. Only the values of sales are generated and no cost price is generated for the MDS full color and the MDS monochrome color, so that values of posted gloss profits thereof become large unreasonably. This configuration arises a problem in that the profit for each of the items corresponding to the pieces of merchandise and the services cannot be managed appropriately.

In contrast, in the embodiment, the cost prices of the pieces of merchandise corresponding to the services that are provided to the customers can be specified using the above-mentioned purchase information and contract information. This specification manner enables the cost prices of the pieces of merchandise (for example, MFP maintenance service, MFP rental service, and resident service) corresponding to the services (for example, MDS full color and MDS monochrome color) that are provided to the customers to be specified even when the form of the services and the form of the pieces of merchandise are different. In addition, profit management for each piece of merchandise and each service can be performed appropriately by executing the processing of transferring the cost prices of the pieces of merchandise corresponding to the services as the raw prices of the services.

In embodiments of present invention, for example, the above-mentioned first acquiring unit 201 may also execute the functions of the purchase information management device 100 without proving the purchase information management device 100, for example. In the same manner, the above-mentioned second acquiring unit 202 may also execute the functions of the contract information management device 300 without proving the contract information management device 300, for example. In the same manner, the above-mentioned third acquiring unit 203 may also execute the functions of the usage amount information management device 400 without proving the usage amount information management device 400, for example.

In summary, it is sufficient that the service provision system 20 is configured by one or more information processing devices. In other words, the service provision system 20 may be configured by one information processing device or configured by a plurality of information processing devices. In this example, it can be considered that the above-mentioned service provision system 20 corresponds to an “information processing system” in the scope of the invention or the above-mentioned accounting data management device 200 corresponds to an “information processing system” in the scope of the invention. Moreover, it can be considered that the above-mentioned system 1 itself including the electronic apparatuses such as the MFP 10 and the LP 11 corresponds to the “information processing system” in the scope of the invention. In this example, it can be considered that the above-mentioned accounting data management device 200 corresponds to the “information processing system” in the scope of the invention.

Although the electronic apparatuses are image forming apparatuses including the MFPs 10 and the LPs 11 in the above-mentioned embodiment, the electronic apparatus may be an apparatus other than the image forming apparatus, such as a projector, a television conference system, a digital camera, an electronic blackboard, a mobile terminal, and a cellular phone, as examples. The electronic apparatus to which the invention is applied can include at least a storage unit that stores therein usage amount information indicating usage amounts of the functions of the electronic apparatuses, and a transmission unit that transmits the usage amount information stored in the storage unit to the information processing device in accordance with an acquisition request from at least one information processing device of one or more information processing devices.

Although the unit prices indicated by the pieces of unit price information contained in the contract information (contract information corresponding to a contract for receiving services in the form different from the pieces of merchandise) of the customer A are set to the same value for the respective MFPs 10 in the above-mentioned embodiment, the unit prices are not limited to be set in this manner. For example, the unit prices may be different depending on model types. Furthermore, for example, the unit prices may be different depending on the functions of full-color copy, monochrome-color copy, and the like.

Although the profit information of the MDS full color and the profit information of the MDS monochrome color are calculated by a unit of the customer in the above-mentioned embodiment, they are not limited to be calculated in this manner. For example, they may be calculated by a unit of an apparatus model. The calculation method therefor is the same as that in the above-mentioned embodiment. For example, when unit prices different depending on the apparatus models are set, it is desired that the pieces of profit information of the MDS full color and the MDS monochrome color are managed for each apparatus model. The above-mentioned mode is particularly effective in such a case.

The above-mentioned embodiment and various variations can be arbitrarily combined.

### Program

Programs that are executed by the service provision system 20 in the above-mentioned embodiment may be recorded and provided in a computer-readable recording medium such as a compact disc read only memory (CD-ROM), a flexible disk (FD), a compact disc recordable (CD-R), a digital versatile disc (DVD), and a universal serial bus (USB) as an installable or executable file or may be provided or distributed via a network such as the Internet. Various programs may be embedded and provided in a non-volatile recording medium such as ROM, for example.

The embodiment of the present invention can appropriately perform profit management for each piece of merchandise and each service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system including one or more information processing devices, the information processing system comprising:
a specifying unit configured to specify a cost price of merchandise corresponding to service identification information using:
first information in which each of a plurality of pieces of apparatus identification information identifying a plurality of electronic apparatuses is associated with the cost price of the merchandise for providing a service linked to the corresponding electronic apparatus; and
second information in which the pieces of apparatus identification information identifying the electronic apparatuses are associated at least with the service identification information identifying the service.

2. The information processing system according to claim 1, wherein the service and the merchandise are provided in different forms.

3. The information processing system according to claim 2, wherein
in the second information, the apparatus identification information, the service identification information, and unit price information indicating a predetermined unit price, of a usage amount of a function of the electronic apparatuses are associated with one another,
the information processing system further comprises:
an acquiring unit configured to acquire usage amount information indicating the usage amount of the function of the electronic apparatuses;
a first calculating unit configured to calculate compensation for the service that is identified by the service identification information using the usage amount information and the second information; and
a second calculating unit configured to calculate a value obtained by subtracting the cost price of the merchandise corresponding to the service identification information from the compensation for the service that is identified by the service identification information as profit information indicating a profit of the service that is identified by the service identification information.

4. The information processing system according to claim 3, wherein
a plurality of types of the service identification information are associated with the apparatus identification information contained in the second information and the unit price information is associated with each type of the service identification information,
the first calculating unit calculates compensation for the service that is identified by the service identification information for each piece of the service identification information using the usage amount information and the second information, and
the second calculating unit calculates, for each piece of the service identification information, as a raw price of the service that is identified by the service identification information, a value obtained by distributing the cost price of the merchandise corresponding to the apparatus identification information to which the service identification information is linked in accordance with the compensation for the service that is identified by the service identification information, and calculates, as the profit information of the service that is identified by the service identification information, a value obtained by subtracting the raw price of the service that is identified by the service identification information from the compensation for the service that is identified by the service identification information.

5. The information processing system according to claim 3, wherein the second calculating unit performs processing of transferring the cost price of the merchandise corresponding to the service identification information as a raw price of the service, that is identified by the service identification information so as to generate accounting data indicating the profit information for each service, and each piece of merchandise.

6. The information processing system according to claim 1, wherein the electronic apparatuses are image forming apparatuses.

7. The information processing system according to claim 4, wherein
the electronic apparatuses are image forming apparatuses,
the types of the service identification information contain first service identification information identifying the service that allows the customer to use a full-color copy function and second service identification information identifying the service that allows the customer to use a monochrome-color copy function, and
the unit price information corresponding to the first service identification information indicates a predetermined unit price of full-color copy per sheet and the unit price information corresponding to the second service identification information indicates a predetermined unit price of monochrome-color copy per sheet.

8. An electronic apparatus that is used in the information processing system according to claim 1.

9. An information processing method comprising:
specifying a cost price of merchandise corresponding to service identification information using:
first information in which each of a plurality of pieces of apparatus identification information identifying a plurality of electronic apparatuses is associated with the cost price of the merchandise for providing a service linked to the corresponding electronic apparatus; and
second information in which the pieces of apparatus identification information identifying the electronic apparatuses are at least associated with the service identification information identifying the service.

10. A non-transitory computer-readable recording medium that contains a computer program that causes a computer to execute:
specifying a cost price of merchandise corresponding to service identification information using:
first information in which each of a plurality of pieces of apparatus identification information identifying a plurality of electronic apparatuses is associated with the cost price of the merchandise for providing a service linked to the corresponding electronic apparatus; and
second information in which the pieces of apparatus identification information identifying the electronic apparatuses are at least associated with the service identification information identifying the service.
